(19) United States
(12) Patent Application Publication
(10) Pub. No.: US 2005/0286257 A1
(43) Pub. Date: Dec. 29, 2005

(54) Modular trailer hitch accessory with decorative and interchangeable elements

(76) Inventors: Thomas Davis Trimmer, Birmingham, MI (US); Godofredo Catolico Gannod, Royal Oak, MI (US)

Correspondence Address: THOMAS D. TRIMMER, 954 SUFFIELD RD, BIRMINGHAM, MI, 48009, US

(21) Appl. No.: 10/878,931

(22) Filed: Jun. 29, 2004

(51) Int. Cl. B60Q 1/00; B60Q 3/00

(52) U.S. Cl. 362/485

(57) ABSTRACT

The previous invention of decorative accessories which are designed to be placed in a trailer hitch receiver, function as hitch steps, have permanent decorative elements and also have the capacity to hold a display placards are the base concept for the present invention. The present invention is an improvement of the previous inventions, to which such improvements include provisions to further enhance the capacity to individualize the hitch receiver apparatus. The current invention consists of a decorative trailer hitch insert that is capable of holding a display placard and has the further provision for interchangeable decorative elements such as step plates, end tubes, various componential additions and various surface treatments.

### CROSS-REFERENCE TO RELATED APPLICATIONS

Not applicable

### STATEMENT REGARDING FEDERALLY SPONSORED RESEARCH DEVELOPMENT

Not applicable

### REFERENCE TO SEQUENCE LISTING, A TABLE, OR A COMPUTER PROGRAM LISTING COMPACT DISK APPENDIX

Not applicable

### BACKGROUND OF THE INVENTION

The recent trend towards customization of vehicles has led to the invention of several automotive aftermarket devices which attempt to personalize a vehicle to the preferences of the owner. These devices include various types of hubcaps, bumpers, running boards and hitch steps. Previous inventions of decorative accessories in the form of lighted hitch inserts only allow the attachment of interchangeable placards to display individualized signage. The design of the aforementioned inventions consists in general, a trailer hitch receiver tongue insert attached by way of a perpendicular weldment to a rectangular box which contains a tight source. Also there may be one or more permanent design elements attached to the light box by way of permanent weldment, or otherwise permanently attached to this box: Such as closed end tubes which extend beyond and parallel to the rectangular box containing the light and/or a step plate attached to the top of said box. The prior inventions of this nature are designed to be a singular welded unit or otherwise constructed with permanently attached components. The drawbacks of such designs are mainly, but not limited to:

Limited individualization: A non-modular decorative hitch insert can only be finished in a singular tone, depending on finishing process. This only allows the end user the option of a monochromatic or singular finish. This doesn't allow the end user the ability to have multiple colors of the apparatus to match multiple vehicles or multi colored vehicles. The cost of customized paint jobs would be prohibitive were the end user were to desire a multi colored hitch insert.

Restriction of replaceability: As with all items that are on or can be attached to vehicles, there is the possibility of damage due to accident, wear and tear, corrosion and exposure to the elements. The previous designs only allow complete replacement of, or major overhaul of the entire apparatus were it to be suffer from any form of damage. This can add a great deal of cost to the end user if the apparatus were in need of repair.

Reduced interchangeability: The prior inventions only allow the purchaser to choose one decorative style of apparatus. Although the placards themselves are interchangeable, the other elements on such devices are not. Elements such as, color of the body, color of the decorative end tubes, finish of the end tubes, shape of the end tubes, color of the step plate, shape of the step plate, finish of the step plate, size of the hitch receiver, or attachments of other various accessories (i.e. tow hooks, cut out metal display plates, auxiliary lighting, reflectors etc.).

Manufacturing limitations. The design of the previous inventions restrict the manufacturers ability to mass produce the invention. Not only do the single piece designs hinder fabrication of the apparatus but the finishing process can also be seriously hindered. The construction and aesthetic quality of the apparatus suffers from limitations in the coating process (i.e. powder coating, chroming, E-Coating, Zirconium Nitrate, electroplating and guilding). The nature of the single body designs do not allow separate components to be coated prior to the final welding process. When fully welded the body of such apparatus would reveal “dead space” to which either paint or many other coatings will not stick, adhere or otherwise apply. In the painting process, another issue with the single piece design is the tendency for pooling of either paint or of cleaning solutions used prior to the painting process. This can result in adversely thick sections of paint, as well as diluted and thin sections of paint. Also, in many of the electroplated applications, the shape of the fully welded unit will reveal areas that remain “outside the path of least resistance” of the electrical current resulting in incomplete or thin coverage of electroplated metal coatings. Another construction limitation in the single piece apparatus is warehousing. Not only is the shape of the fully assembled unit awkward and bulky to store, but if a completed unit is damaged, the entire assembly must be completely stripped and refinished. Yet another factor limiting the manufacture of the single piece assembly is the cost. The process required in the fully welded the unit increases the construction time and expense. Much of the construction can only be done by skilled and certified welders who demand much higher wages than other semi-skilled workers. Not only does the welding process take time, but there is additional time required for metal finishing such as sanding, grinding and deburring that follows almost any welded process. Although some of the metal finishing work can be done by semi-skilled workers, there may be “down time” for the skilled workers while they are waiting for these procedures to be completed.

### SUMMARY OF THE INVENTION

The object of the invention presented herein includes a lighted form of decorative hitch accessory which allows the attachment of interchangeable placards to display individualized signage. The design of the invention consists in general, a trailer hitch receiver tongue insert attached by way of a perpendicular weldment to a rectangular box housing which contains a light source, and to said housing are a means for affixing modular design modifications such as, but not limited to, interchangeable step plates, interchangeable end tubes, end caps for interchangeable end tubes, mounting holes for attachment of interchangeable end tubes, mounting holes for attachment of interchangeable step plates and accesorizeable hitch receiver tongue.

One modification of the Modular Trailer Hitch Accessory is a step plate and a means to attach and remove step plates of varying size, shape, color, finish and materials.

Another modification of the Modular Trailer Hitch Accessory are end tubes and a means to attach and remove end tubes of varying size, shape, color finish and materials.

On the said end tubes of the Modular Trailer Hitch Accessory is a means to attach and remove sheaths of varying design, attach and remove auxiliary lighting, and attach and remove caps of varying size. Also included with said tubes is the provisions for surface treatments including color, finish and materials, to the aforementioned end tubes.

One object of the Modular Trailer Hitch Accessory is the provision for replacement of warn out or otherwise damaged components attached to the hitch accessory. The ability of the improvement to allow components to be replaced for reasons due to damage without having to replace the entire unit. The end user can have considerable savings by simply changing the damaged part of an otherwise useable unit. Without this improvement, the end user would have to replace or discard an entire unit due to otherwise minor damage.

Another object of the Modular Trailer Hitch Accessory is improved individualization in accordance with the taste and preference of the end user. The modular aspect of the invention allows the end user the capacity to further individualize the device without significantly increasing price for either end user or the manufacturer. It allows processes such as, electroplating, chroming, Zirconium Nitrate, guilding, powder coating, E-coating and custom painting. All of these finishes can be done without a major modification or refinishing to the housing of the main body. Also, this allows the aforementioned processes to be performed to limited numbers of the components thus, the manufacturer can provide product to individual preferences without being required to mass produce a single surface finish or componential style.

Another object of the Modular Trailer Hitch Accessory is component interchangeability allowing the end user the capacity to change the appearance without requiring the purchase of an entirely new apparatus. The capacity for the individual end user to have interchangeable components allows the ability to have multiple styles without the need to buy multiple units. This allows the unit to be placed on vehicles of differing color schemes, finishes, etc. simply by changing the components. For example; A unit can one day be fitted with chrome components, the next day they unit can be fitted with components which have gold, flames, etching, or any desired surface treatment. The interchangeable feature of the invention gives the end user the ability to, for example, to continually accessorize and re-accessorize a single unit with different colors, treatments and design schemes.

Yet another object of the Modular Trailer Hitch Accessory is improved manufacturability. The nature of the bolt on, screw on, and glue on components in the modular construction of the device allows the manufacturer to reduce the amount of welding, thus reducing the billable time required by the more expensive skilled workers such as welders. Much of the construction can then be carried out by non-skilled or semi-skilled workers. Another aspect of the components is the nature of many of the existing surface treatment or coating processes. The singular, one piece design of the previous invention is hindered greatly by many coating processes. The finishing flaws that would occur include, incomplete coverage resulting in exposed metal surfaces, pooling, thin coverage, and fragile coverage resulting in chipping and flaking. All of these finishing flaws can result in rust and corrosion, thus significant loss of structural integrity and aesthetic quality. The separate, hence smaller and less complex components can be more easily painted, electroplated or otherwise coated. However, if there is a flaw found in any of the smaller components, it can be either discarded or reprocessed at no great expense. Another benefit is that the components can be built and warehoused according to the capacity of the manufacturer or the demand for a certain style of the apparatus. If components are warehoused in an -unassembled form, this consolidates the storage space thus increasing the capacity for storage of units. A unit stored unassembled reduces the risk of damage, if a single component on an apparatus is damaged, it can easily be replaced. Also, if the apparatus is constructed out of separate components, each component can be mass produced separately and stored. The single piece unit must be completed in a single continuous process in order to be warehoused, whereas, manufacturing the unit in components allows for the units to be built in stages. While one component is being finished, painted or coated, a worker can proceed to another component reducing the risk of “down time”. If the all of the components are completed, including welding, coating, surface treatments and then stored in separately, the final assembly of the fully functional unit can be postponed. This adds the capacity for the apparatus stored in the 90% complete stage indefinitely. This can in turn, effectively improve time management and cut the cost of even the nonskilled workers.

### PREFERRED EMBODIMENT OF THE INVENTION

The preferred embodiment of the invention includes the design for purpose and function as outlined, but not limited to, a Modular Trailer Hitch Accessory in which the main constituents being; an illuminated boxlike housing; a colored diffuser lens 13; a means such as screws 4 to attach a placard 3 for displaying various indicia 5; a means such as a hitch insert tongue 1 to attach said apparatus to a trailer hitch receiver; a means such as a wire 10 to attach said apparatus to the vehicle electrical system; to which the following general components embody the constituents to the current invention. The components are:

A generally rectangular, metallic boxlike housing 14 consisting of, a rectangular tube. The tube consists of, a front surface 24, a rear surface 25, a top surface 26, a bottom surface 27 and the two opposing ends of the tube.

On the two opposing ends of said rectangular tube of the boxlike housing 14 are mounting plates 19 which are attached via circumfirencial weldment 12 to the open ends. On said mounting plate are a means for screws 17, bolts, threading, or other means to removably attach decorative components such as end tubes 2. Said end tubes 2 include, but not limited to, straight tubes FIG. 11, square tubes, rectangular tubes, curved tubes, painted or colored by any other means including, electroplating, E-Coat, powder coat, zirconium nitrate, etc..

Also on said mounting plate 19 is an opening 18 as a provision for auxiliary electrical wiring, hoses, internal batteries or any conceivable mechanical or electrical application; and as a provision for improved implementation of finishing, painting or any other treatment process in the manufacture requiring drainage.

Also said mounting plate 19 can accommodate utilitarian items such as hooks, locks, lights, cast plates, bumpers or any other conceivable utility item, which can also be, but not limited to, painted or colored by any other means including, electroplating, E-Coat, powder coat, zirconium nitrate, etc. Within said removably attachable components is a means to mate or otherwise remove or attach said component.

Said mounting plate is a provision for removably attachable items such as but not limited to end tubes 2. Said end tube 2 can be of various shapes sizes and materials an finished in various color and be further modified by varying treatments such as end caps 6 and gaskets 9. Said end tubes are attached by a means such as screw holes 22 and/or mounting bracket 23.

Also, on said rear surface 25 of the metallic boxlike housing is attached, via perpendicular weldment 11, a hitch insert tongue 1, consisting of a square tube. In said square tube are holes 8 which are drilled or punched to accommodate a pin or other form of locking device for use in trailer hitch receivers. These holes 8 are drilled in an axial relationship parallel to the rectangular metallic boxlike housing.

Also on the rear surface 25 of the tube are attachment points , preferably in the form of screw holes 15 or any other means to removably attach a step plate 7. Said attachment points 15 are located in relation to the mating bracket 21 on the step plates 7. The material of said step plate 7 is metal or other heavy duty material, generally rectangular and of thickness to eliminate flex when weight is applied. Said material can consist of one or any combination of form including, diamond plate, diamond cut mesh, smooth plate, rough plate, grooved plate, slotted plate, formed sheet metal, cast metal, wood, plastic, rubber, or any other synthetic material conducive to such application. Said generally rectangular step may vary in color, finish or any aesthetic variation, including shape (i.e. rounded corners, curved edges, length, width, thickness). The said step plate 7 can be painted or colored by any other means including, electroplating, E-Coat, powder coat, zirconium nitrate, etc.. The step plate 7 is by preference but not limited to, removably attached, parallel to the plane of the top surface 26 of the, said rectangular metallic boxlike housing 14 via the mounting brackets 21 and screw holes 20 in relation to the mounting holes 15 on the rear surface and proprietary auxiliary adhesive gasket 31.

Also on the rear surface 25 of the rectangular metallic boxlike housing 14 is an opening 16. Said opening 16 is a hole that is cut to accommodate an electrical harness 10 which allows the completion of a circuit between the electrical system of the vehicle through the trailer hitch wiring receptacle and the lighting module contained within the boxlike housing 14. Also, in said opening is a provision for a grommet 30 which can facilitate a water resistant seal. When the vehicle's lighting system is activated, said lighting module is illuminated.

On the said front surface 24 of the rectangular metallic box is an opening 28, generally rectangular, in proportion to the length and width of the metallic box 14. Said opening is a provision for a means of illumination preferably an LED bar 29. Located in relation to the narrow ends of said openings are a means for the attachment of a colored diffuser lens, preferably but not limited to screws 4. Also, said screws 4 are a means to attach a placard 3 to which can be placed multiple or various indicia 5 or signage placard 3.

Said openings on the rear surface 25, front surface 24 and welded end mounting plates 19 are as designed, capable of accommodating gaskets 9, grommets 30, end caps 6, sealant or any other method of attaining a water resistant housing.

The applications and embodiments which have been described concerning the present invention would be apparent to those skilled in the art, and from these applications can be derived various changes, modifications, enhancements, alterations and accessories which can be made without departing form the scope of the inventive concepts therein.

### BRIEF DESCRIPTION OF THE DRAWINGS

The invention will be better understood and objects other than those set forth will become apparent when detailed description is given consideration. Such description makes reference to the annexed drawings wherein.

FIG. 1 is a perspective view of the Modular Trailer Hitch Accessory with all modular components removed as described in the above claims.

FIG. 2 is a perspective view of the preferred embodiment of the Modular Trailer Hitch Accessory with attached general modular components as described in the above claims including, step plate as defined in claim 1, end tubes as defined in claim 2, and sign placard.

FIG. 3 is a top view of the invention as defined in claim 3-5 with modular step plate, modular end tubes and sign placard removed.

FIG. 4 is a front view with modular step plate, modular end tubes, the screws and diffuser lens removed revealing a bar of LED's as described in the preferred embodiments of the invention.

FIG. 5 is a front view of the invention with modular step plate, modular end tubes and sign placard removed showing attached diffuser lens and front surface of the boxlike housing..

FIG. 6 is a rear view of the invention with the step plate component attached showing the attachment points of the step plate as defined in claim 3 and the mounting brackets as defined in claim 1 and the proprietary adhesive gasket as described in the preferred embodiments of the invention.

FIG. 7 is a rear view of the invention with modular step plate and modular end tubes removed which displays mounting holes for attachment of step plates as defined in claim 3 and provision for grommet as defined in claim 4.

FIG. 8 is a side view of the invention with modular step plate and modular end tubes removed showing trailer hitch pin holes and; mounting holes on end tube mounting plate as defined in claim 5 and mounting holes as defined in claim 3.

FIG. 9 is a perspective of a modular step plate as defined in claim 1.

FIG. 10 is a front view of the modular step plate revealing the mounting brackets as defined in claim 1.

FIG. 11 is a view of the modular end tube showing the internal mounting bracket as defined in claim 2.

FIG. 12 is a perspective view of a straight end tube with end cap in place as defined in claim 2 and a seating gasket as defined in claim 4.

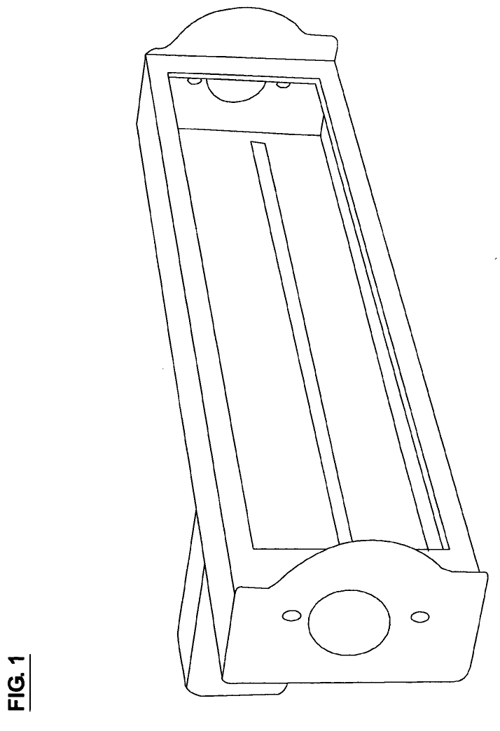

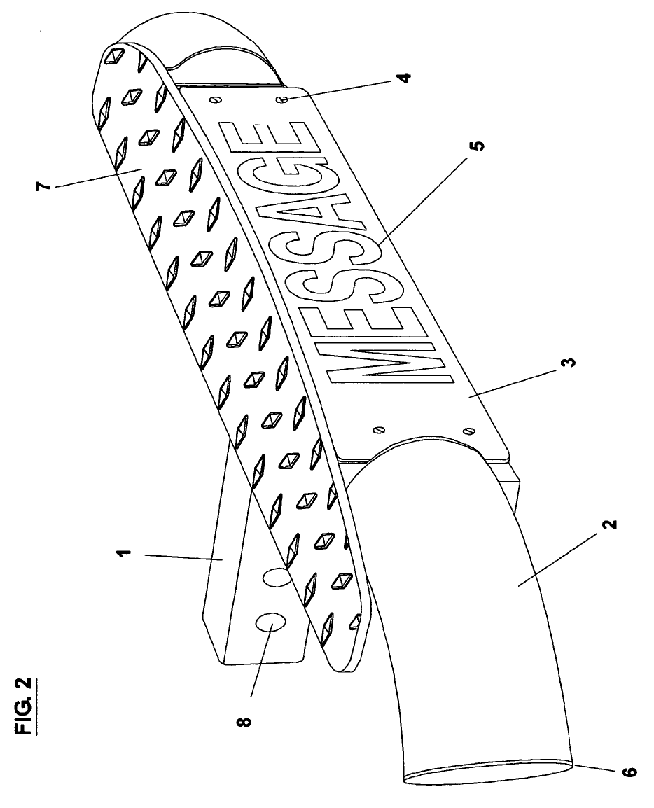

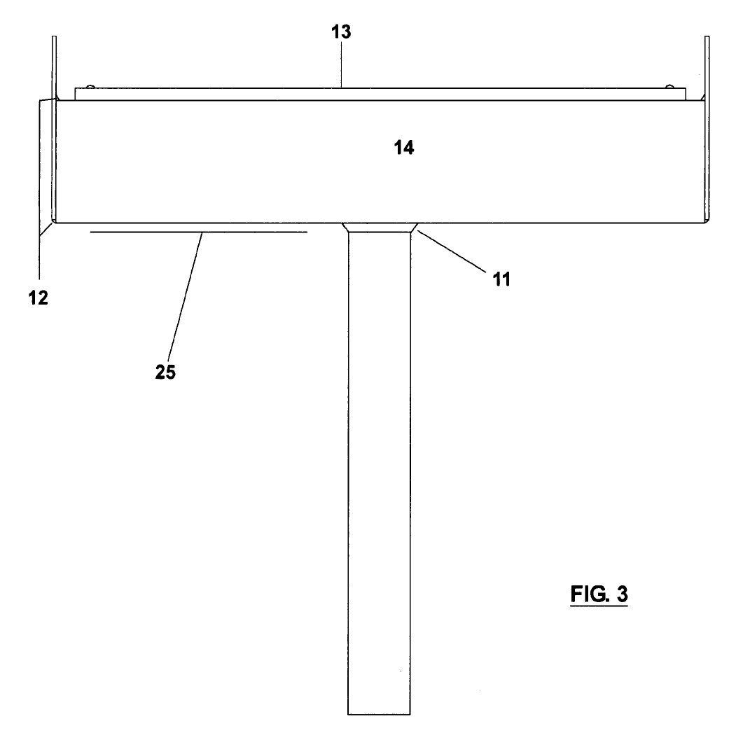

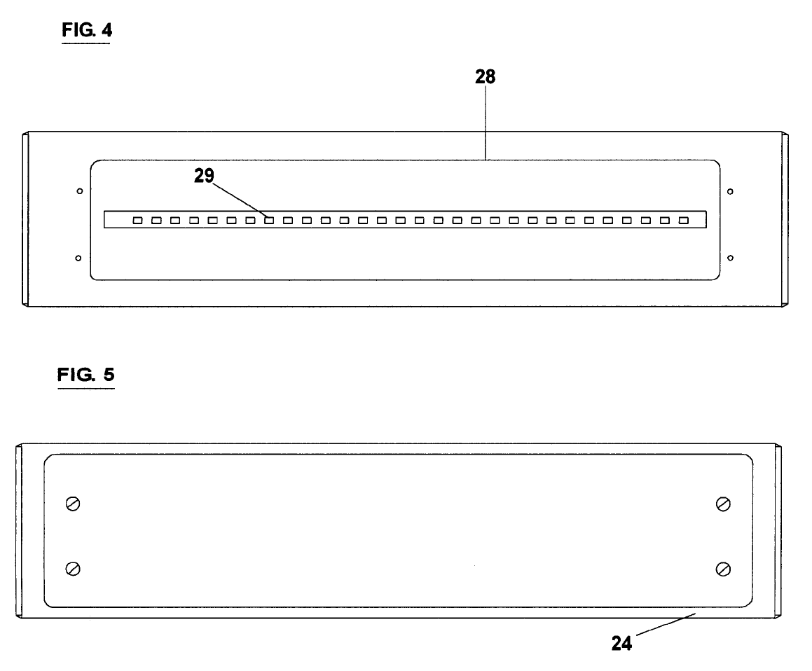

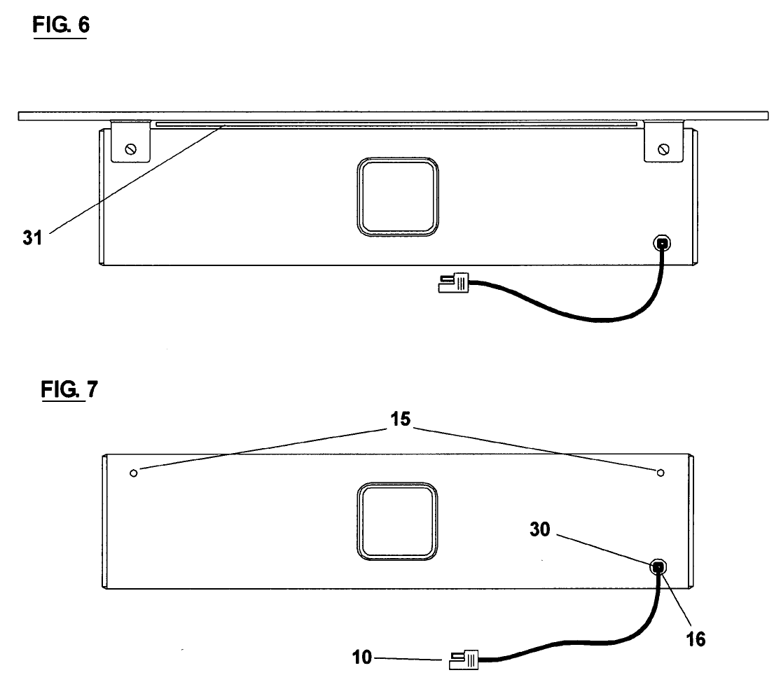

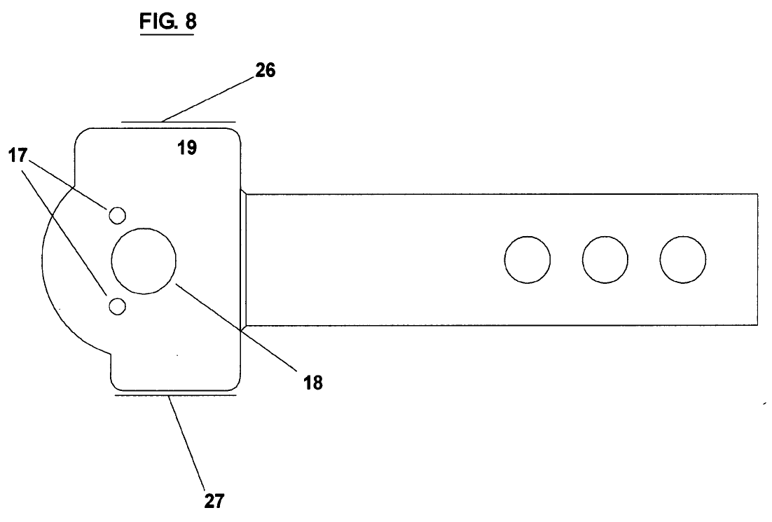

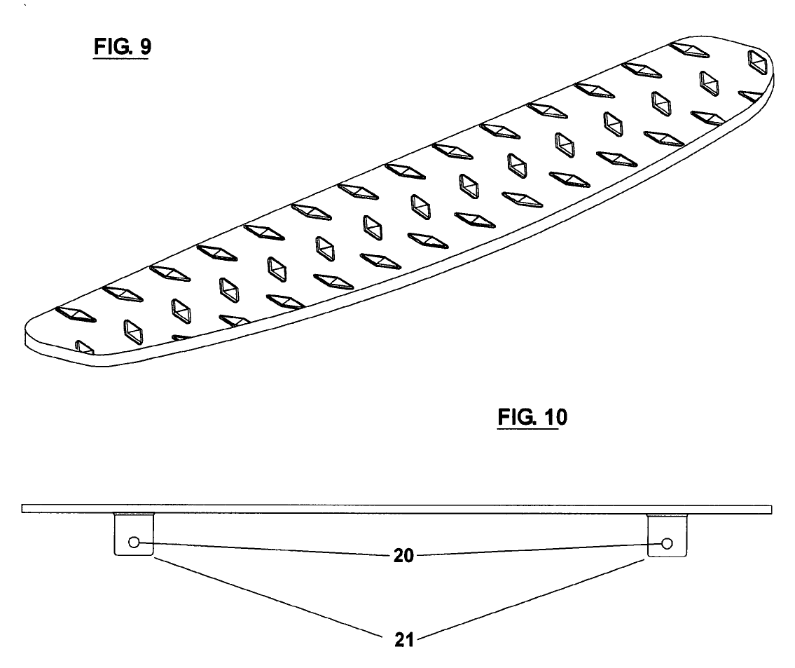

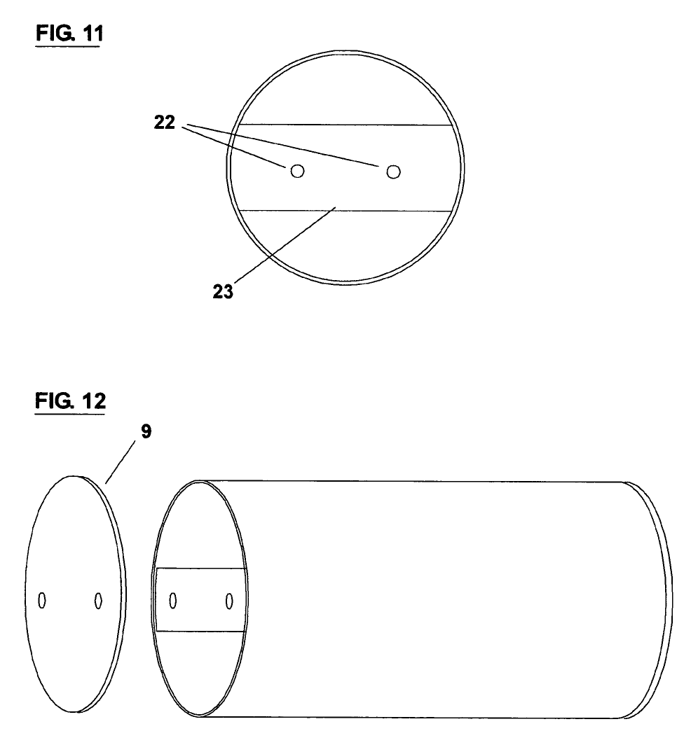

1. An apparatus as described but not limited to, a Modular Trailer Hitch Accessory in which the main constituents being; an illuminated boxlike housing; a colored diffuser lens; a means to attach a placard for displaying various indicia; a means to attach said apparatus to a trailer hitch receiver; a means to attach said apparatus to the vehicle electrical system; and for the purpose and objects of the current invention, to the said apparatus are the general features including, but not limited to,
a modular light box housing, interchangeable step plates, interchangeable end tubes, end caps for interchangeable end tubes, mounting holes for attachment of interchangeable end tubes, mounting plate, mounting holes for attachment of interchangeable step plates, accesorizeable hitch receiver tongue and,
a decorative interchangeable removably attached step plate which is customizable in such ways as, but not limited to, color, shape, material, treatment and finish,
and,
a means to removably attach said step plate such as but not limited to mounting holes, brackets or any other means for attachment of said interchangeable removably attachable step plates.

2. An apparatus as described but not limited to, a Modular Trailer Hitch Accessory in which the main constituents being; an illuminated boxlike housing; a colored diffuser lens; a means to attach a placard for displaying various indicia; a means to attach said apparatus to a trailer hitch receiver; a means to attach said apparatus to the vehicle electrical system; and for the purpose and objects of the current invention, to the said apparatus are the general features including, but not limited to,
a modular light box housing, interchangeable step plates, interchangeable end tubes, end caps for interchangeable end tubes, mounting holes for attachment of interchangeable end tubes, mounting plate, mounting holes for attachment of interchangeable step plates, accesorizeable hitch receiver tongue and,
decorative interchangeable removably attached end tubes which is customizable in such ways as, but not limited to, color, shape, material, treatment and finish,
and,
a means to removably attach end tubes such as but not limited to mounting holes, brackets or any other means for attachment of said interchangeable removably attachable end tubes.

3. An apparatus as described but not limited to, a Modular Trailer Hitch Accessory in which the main constituents being; an illuminated boxlike housing; a colored diffuser lens; a means to attach a placard for displaying various indicia; a means to attach said apparatus to a trailer hitch receiver; a means to attach said apparatus to the vehicle electrical system; and for the purpose and objects of the current invention, to the said apparatus are the general features including, but not limited to,
a modular light box housing, interchangeable step plates, interchangeable end tubes, end caps for interchangeable end tubes, mounting holes for attachment of interchangeable end tubes, mounting plate, mounting holes for attachment of interchangeable step plates, accesorizeable hitch receiver tongue and,
a modular light box housing which is customizable in such ways as, but not limited to, color, shape, material, treatment and finish,
and,
a means such as, but not limited to mounting holes, brackets or any other means which allows the removable attachment of items such as, but not limited to a step plate as defined in claim 1, end tubes as defined in claim 2 and other decorative elements including plates, bars, grills or utilitarian elements such as auxiliary lighting, tow hooks, winches, bumpers or bike racks.

4. An apparatus as described but not limited to, a Modular Trailer Hitch Accessory in which the main constituents being; an illuminated boxlike housing; a colored diffuser lens; a means to attach a placard for displaying various indicia; a means to attach said apparatus to a trailer hitch receiver; a means to attach said apparatus to the vehicle electrical system; and for the purpose and objects of the current invention, to the said apparatus are the general features including, but not limited to,
a modular light box housing, interchangeable step plates, interchangeable end tubes, end caps for interchangeable end tubes, mounting holes for attachment of interchangeable end tubes, mounting plate, mounting holes for attachment of interchangeable step plates, accesorizeable hitch receiver tongue and,
a modular light box housing which is customizable in such ways as, but not limited to, color, shape, material, treatment and finish,
and,
provision for gaskets, grommets, silicone sealant, plugs or any other means to seal or otherwise protect the said modular light box from intrusion of elements such as rain or snow.

5. An apparatus as described but not limited to, a Modular Trailer Hitch Accessory in which the main constituents being; an illuminated boxlike housing; a colored diffuser lens; a means to attach a placard for displaying various indicia; a means to attach said apparatus to a trailer hitch receiver; a means to attach said apparatus to the vehicle electrical system; and for the purpose and objects of the current invention, to the said apparatus are the general features including, but not limited to,
a modular light box housing, interchangeable step plates, interchangeable end tubes, end caps for interchangeable end tubes, mounting holes for attachment of interchangeable end tubes, mounting plate, mounting holes for attachment of interchangeable step plates, accesorizeable hitch receiver tongue and,
a tube closed on each end with a mounting plate which accommodates the attachment of items such as but not limited to end tubes as defined in claim 2
and,
an opening; as a provision for future design considerations such as auxiliary electrical wiring, hoses, internal batteries or any conceivable mechanical or electrical application; and as a provision for improved implementation of finishing, painting or any other treatment process in the manufacture requiring drainage.
